(19) United States
(12) Patent Application Publication
(10) Pub. No.: US 2025/0140094 A1
(43) Pub. Date: May 1, 2025

(54) PORTABLE FIRE ALARM DEVICE AND A METHOD OF OPERATION THEREOF

(71) Applicant: Carrier Corporation, Palm Beach Gardens, FL (US)

(72) Inventors: Rajiv Ranjan, Riverview, FL (US); Jennifer Alexander, Minneapolis, MN (US); Marcin Piech, East Hampton, CT (US)

(21) Appl. No.: 18/920,908

(22) Filed: Oct. 20, 2024

Related U.S. Application Data
(60) Provisional application No. 63/593,582, filed on Oct. 27, 2023.

(51) Int. Cl. G08B 17/10; G08B 25/14

(52) U.S. Cl. CPC G08B 17/10; G08B 25/14

(57) ABSTRACT

Embodiments of the disclosure describe systems and methods for a portable fire alarm device. The device includes a sensing unit configured to a sensing unit configured to receive signals from at least one of on-board sensors and remotely located sensor devices to generate sensor related data. The device also includes an alert generation unit configured to generate an alert based on the sensor-related data indicating a potential fire hazard. The device also includes a power unit comprising at least a pluggable power interface to enable a connection of the portable fire alarm device with an Alternating Current (AC) outlet to supply power to the sensing unit and the alert generation unit to generate the alert. The device further includes an interface module configured to establish a connection with a communication module of another device to send the generated alert to one or more external electronic devices.

### CROSS REFERENCE TO RELATED APPLICATION

This application claims the benefit of U.S. Provisional Patent Application No. 63/593,582 filed on Oct. 27, 2023, which is incorporated by reference herein in its entirety.

### FIELD OF THE INVENTION

The disclosure generally relates to hazardous condition detectors, and more particularly relates a portable fire alarm device for unconditional spaces and a method of operation thereof.

### BACKGROUND

Fire alarm systems are safety devices designed to detect smoke, heat, or flames and alert occupants of a potential fire hazard. The fire alarm systems typically consist of smoke detectors, heat sensors, alarms, and control panels, enabling timely response to prevent loss of life and property. Currently, there are various fire alarm systems that are good solutions for fire detection in conditional spaces like a house or an office. However, such fire alarm systems fail to effectively detect a potential fire hazard in unconditional spaces like garages, remote storage sheds with battery-based devices, covered electric vehicle charging stations, workshops with battery-based devices, remote manufacturing facilities with battery-based devices, and/or any other covered space including battery-based devices, where factors like dust, pollution, and space impact the accuracy of such fire alarm systems. For instance, the surge in Electric Vehicles (EVs) adoption in sustainable transportation, has also brought about a new concern regarding fire hazards within confined spaces, such as garages used to park the EVs. The substantial energy stored in EV batteries (for example, Lithium Ion (Li-Ions) batteries) makes the EV batteries susceptible to overheating, especially in such confined spaces.

Further, the conventional fire alarm systems are complex and require extensive human efforts in installation and maintenance. Also, the conventional fire alarm systems are based on a limited number of sensors, majorly based on temperature sensors neglecting the other possible scenarios that can lead to potential fire hazards. Furthermore, the installation costs of the conventional fire alarm systems tend to be high due to factors, such as their size, design, and power requirements. Also, the power management within the conventional fire alarm systems is suboptimal.

Additionally, due to complex structure and high power requirements at the conventional fire alarm systems, it is difficult to install and/or relocate the fire alarm systems.

Therefore, in view of the above-mentioned problems, there is a need to provide an improved fire alarm system.

### SUMMARY

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

Disclosed herein is a portable fire alarm device. The portable fire alarm device comprises a sensing unit configured to receive a plurality of signals from at least one of one or more on-board sensors and one or more remotely located sensor devices to generate sensor related data corresponding to an environment. Further, the portable fire alarm device comprises an alert generation unit configured to generate an alert based on the sensor-related data indicating a potential fire hazard within the environment. Moreover, the portable fire alarm device comprises a power unit comprising at least one of a pluggable power interface to enable a connection of the portable fire alarm device with an Alternating Current (AC) outlet to supply power to the sensing unit and the alert generation unit to generate the alert, a power interface to enable a connection of the portable fire alarm with an external Direct Current (DC) power source to supply power to the sensing unit and the alert generation unit to generate the alert, and an internal DC power source configured to supply power to the sensing unit and the alert generation unit to generate the alert. The external DC power source comprises a battery powered device. The battery powered device may include a battery source as primary power supply. Example of the battery source may include, but not limited to, a Li-ion battery, a lead-acid battery, and so forth. Furthermore, the portable fire alarm device comprises an interface module configured to establish a connection with a communication module of another device to send the generated alert to one or more external electronic devices. The another device comprises at least one of a smart lock device, an Internet of Thing (IoT) home device, and an external alarm system.

In one or more embodiments, the sensor-related data indicates at least one of a change in temperature, a detection of flame, a detection of a target gas, or a detection of smoke in the environment.

In one or more embodiments, the alert generation unit is configured to compare the at least one of the change in the temperature, the detection of flame, the detection of the target gas, or the detection of smoke in the environment with a corresponding predefined criteria to determine whether the received sensor-data corresponds to the potential fire hazard.

In one or more embodiments, the at least one of the one or more on-board sensors and the one or more remotely located sensor devices comprises at least one of a temperature sensor, a gas sensor, a smoke sensor, and a flame sensor.

In one or more embodiments, the alert corresponds to at least one of an activation of one or more visual indicators, an activation of a sound signal, or a combination thereof.

Also disclosed herein is a method of operation of a portable fire alarm device. The method comprises receiving, via a sensing unit, a plurality of signals from at least one of one or more on-board sensors and one or more remotely located sensor devices for generating sensor related data corresponding to an environment. The method further comprises generating, via an alert generation unit, an alert based on the sensor-related data indicating a potential fire hazard within the environment. The method also comprises performing, via a power unit, at least one of establishing, using a pluggable power interface, a connection of the portable fire alarm device with an Alternating Current (AC) outlet for supplying power to the sensing unit and the alert generation unit to generate the alert. The method also comprises establishing, using a power interface, a connection of the portable fire alarm with an external Direct Current (DC) power source for supplying power to the sensing unit and the alert generation unit to generate the alert. The external DC power source comprises a battery powered device. The method further comprises supplying power, using an internal DC power source, to the sensing unit and the alert generation unit to generate the alert. Further, the method comprises establishing, using an interface module, a connection with a communication module of another device for sending the generated alert to one or more external electronic devices. The another device comprises at least one of a smart lock device, an Internet of Thing (IoT) home device, and an external alarm system.

To further clarify the advantages and features of the methods, systems, and apparatuses, a more particular description of the methods, systems, and apparatuses will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates a schematic block diagram of a portable fire alarm device, according to one or more embodiments of the present disclosure;

FIG. 2 illustrates an exemplary system environment of the portable fire alarm device, according to one or more embodiments of the present disclosure;

FIG. 3 illustrates another system environment of the portable fire alarm device, according to one or more embodiments of the present disclosure;

FIG. 4 illustrate a pluggable configuration of the portable fire alarm device, according to one or more embodiments of the present disclosure;

FIG. 5 illustrates a process flow depicting a method of operation of the portable fire alarm device, according to one or more embodiments of the present disclosure;

FIG. 6 illustrates another process flow depicting a method of operation of the portable fire alarm device, according to one or more embodiments of the present disclosure; and

FIG. 7 illustrates another process flow depicting a method of operating the portable fire alarm device, according to one or more embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, “some embodiments”, “one or more embodiments” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure provides a portable fire alarm system configured to generate an alert indicating a potential fire hazard in a confined space with one or more battery based devices. The portable fire alarm generates the alarm based on sensor data from a plurality of sensor devices. Further, the portable fire alarm system provides a pluggable power interface to enable a direct connection of the portable fire alarm system with an Alternating Current (AC) outlet. Therefore, the portable fire alarm system provides ease in configuring and installing an effective and efficient first alarm system.

Embodiments of the disclosure will be described below in detail with reference to the accompanying drawings.

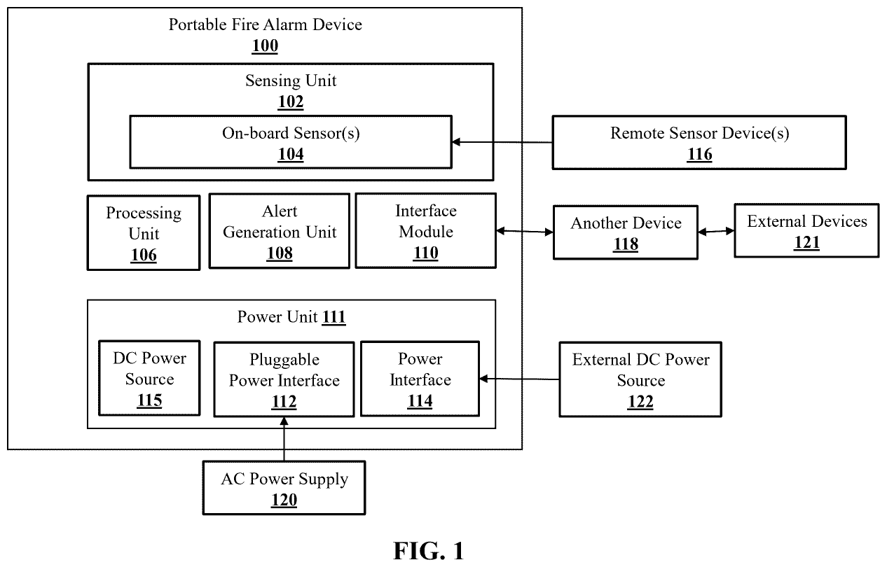

FIG. 1 illustrates a schematic block diagram of a portable fire alarm device 100 (hereinafter referred to as “the device 100”), according to one or more embodiments of the disclosure. The device 100 includes a sensing unit 102, a processing unit 106, an alert generation unit 108, an interface module 110, and a power unit 111.

The device 100 may correspond to a compact and easily transportable device designed to detect a presence of fire or smoke and generate alerts to warn individuals of potential fire danger. The device 100 may generate alarms that are intended to provide timely notifications in various settings, promoting rapid evacuation and response to fire emergencies. The device 100 may be a light-weight device that has a small form factor. Further, the device 100 may support a variety of layouts and/or configurations to be suitably installed at different deployment sites. For instance, the device 100 may be installed over a vehicle, a ceiling of a garage/building, a door lock of a garage/building, a door of the garage/building, and so forth.

The sensing unit 102 of the device 100 may be configured to receive a plurality of signals from one or more sensors. The one or more sensors include, but are not limited to, one or more on-board sensors 104 and one or more remotely located sensor devices 116 (interchangeably referred to as “the remote sensor devices 116”). Examples of the one or more sensors include, but are not limited to, temperature sensors, gas sensors, smoke sensors, and flame sensors. The temperature sensors may be configured to determine a value of temperature in the environment. The temperature sensors are configured to monitor and measure changes in temperature within the environment. Based on different types of technologies used in such temperature sensors, the temperature sensors may be classified as thermal detectors, thermocouples, Resistance Temperature Detectors (RTDs), infrared temperature sensors, and so forth. A temperature sensor is configured to generate an output signal corresponding to the change in temperature when the temperature of the environment rises beyond a specific threshold or at a rapid rate. The smoke sensors, which may also be referred to as the smoke detectors, are devices that are configured to detect the presence of smoke in the environment. The smoke detectors are configured to sense particulate matter and/or aerosols produced by combustion process to identify an initial sign of fire. The smoke detectors may be based on various technologies such as, but not limited to, ionization methods, photoelectric methods, or a combination thereof. The smoke detectors are configured to generate an output signal in response to detection of smoke in the environment. The gas sensors are configured to detect the presence of potentially hazardous gases in the environment, specifically gases that indicate a fire or other hazardous situation. The gas sensors for fire alarms are designed to detect gases such as, but not limited to, Carbon Monoxide (CO), Carbon Dioxide (CO₂), methane (CH₄), hydrogen (H₂), Hydrogen Fluoride (HF), and so forth. When a gas sensor detects the presence of a target gas, the gas sensor generates an output signal corresponding to said detection of the target gas. The flame sensors detect the presence of flames or fires by sensing specific wavelengths of light emitted by flames. The flame sensors operate based on optical sensing technologies and are designed to differentiate between unique characteristics of light emitted by flames and other sources of light, such as sunlight or artificial lighting. Based on the above, a flame sensor generates an output signal corresponding to the detection of flame in the environment.

In one embodiment, the temperature sensors, the gas sensors, the smoke sensors, and the flame sensors discussed above may be implemented as the one or more on-board sensors 104. Further, the one or more remote sensor devices 116 may also include the temperature sensors, the gas sensors, the smoke sensors, and the flame sensors. The one or more on-board sensors 104 may be located within a housing of the device 100. The one or more on-board sensors 104 may be integrated with other components of the device 100. The one or more remote sensor devices 116 may be located remotely to the device 100. Non-limiting examples of different locations of the one or more remote sensor devices 116 may be a battery source of a vehicle, a fuel tank of a vehicle, a ceiling of a garage, and/or near to any flammable object/substance. Embodiments are exemplary in nature, and the one or more on-board sensors 104 or the one or more remote sensor devices 116 may correspond to any suitable sensing device configured to detect fire, smoke, or gases. The sensing unit 102 may be configured to receive the various output signals from each of the above-mentioned sensors to generate sensor-related data corresponding to an environment. The sensor-related data may indicate information such as, but not limited to, a change in temperature, a detection of flame, a detection of a target gas, and/or a detection of smoke in the environment.

The processing unit 106 may be communicably coupled with the sensing unit 102. The processing unit 106 may include specialized processing units such as, but not limited to, integrated system (bus) controllers, memory management control units, floating point units, digital signal processing units, etc. In one embodiment, the processing unit 106 may include a central processing unit (CPU), a Graphics Processing Unit (GPU), or both. The processing unit 106 may be one or more general processors, Digital Signal Processors (DSPs), Application-Specific Integrated Circuits (ASIC), Field-Programmable Gate Arrays (FPGA), servers, networks, digital circuits, analog circuits, combinations thereof, or other now known or later developed devices for analyzing and processing data. In an embodiment, the processing unit 106 may execute a software program, such as code generated manually (i.e., programmed) to perform the desired operation.

The processing unit 106 may be configured to receive the sensor-related data indicating the at least one of the change in the temperature, the detection of flame, the detection of the target gas, or the detection of smoke in the environment, from the sensing unit 102. The processing unit 106 may further be configured to compare the at least one of the change in the temperature, the detection of flame, the detection of the target gas, or the detection of smoke in the environment with corresponding predefined criteria to determine whether the received sensor-data corresponds to a potential fire hazard. The processing unit 106 may be configured to eliminate a chance of false positives by effectively utilizing the sensor-related data generated based on the signals from multiple sensors. The processing unit 106 may validate signals from multiple sensors before utilizing such signals for determination of potential fire hazard. In some embodiments, the processing unit 106 may utilize sensor-related data from at least two sensors to reduce the chances of false positive. For example, the processing unit 106 may compare temperature change against predetermined threshold (e.g. 40 F) designated as primary alarm criterion with change in signal from gas/particulate/smoke sensors (e.g. 10% change against baseline) to confirm whether alarm is due to fire, or it is a false positive. Alternatively, the reverse strategy may be employed where a gas/particulate/smoke sensor signal is monitored as the primary alarm criterion with the change in temperature used to confirm the event as fire or a false positive. Analogously, rather than using change of signal as the appropriate alert criterion, the rate of change of signal in time may be used instead. For example, if the temperature rises 40 F in 10 minutes this may be classified as a false positive, but if that same 40 F rise occurs in 1 minute it may be signifying fire event.

The device 100 includes the alert generation unit 108 that is communicably coupled to the processing unit 106. The alert generation unit 108 may be configured to generate an alert based on the sensor-related data corresponding to the environment. Examples of alerts generated by the alert generation unit 108 may include, but are not limited to, an activation of one or more visual indicators, an activation of a sound signal, or a combination thereof. In some embodiments, the alert generation unit 108 may also be configured to generate sensory alerts to notify the individuals/users within the environment or associated with the device 100, about the potential fire hazard. In an embodiment, the alert generation unit 108 may generate alarm signals such as, but not limited to, sirens, bells, horns, recorded voice messages or other loud audible sounds, to notify the users about the potential fire hazard. In another embodiment, the alert generation unit 108 may generate visible alarm signals such as, but not limited to, bright strobe lights, flashing lights, or other visual indicators that provide a visual indication to the users about the potential fire hazard. The alert generation unit 108 may include and/or be coupled to any suitable device such as, audio speaker, Light Emitting Diodes (LEDs), etc., to generate the above-mentioned alarm signals.

The interface module 110 may be communicably coupled to the processing unit 106 and/or the alert generation unit 108. In an exemplary embodiment, the interface module 110 may be configured to establish a connection with a communication module of another device 118 to send the generated alert to one or more external electronic devices 121. Further, the another device 118 may include, but not limited to, a smart lock device, an Internet of Thing (IoT) home device, or an external alarm system. Examples of the external electronic devices 121 may include, but are not limited to, smartphones, tablets, laptops, personal computers, server computers, building management systems, building security systems, and so forth. The interface module 110 may include a connection port to establish a connection with a communication module of the another device 118 and/or the one or more external electronic devices 121. The interface module 110 may connect to the another device 118 and/or the one or more external electronic devices 121 via any suitable connection means such as, a wired connection and/or a wireless connection. Thus, the alarm may be further relayed through another device containing means of amplifying and furthering the fire warning signal as appropriate. For example, relaying fire signal to a thermostat in a home would allow that thermostat to emit beeping sounds if equipped with a speaker and/or flash a warning message if equipped with a display screen and/or flash a light if equipped with an LED light or other illumination light. Analogously, the alarm signal may be relayed to a smart home device that may initiate a mitigation action in response to the fire alarm. For example, alarm signal at a smart lock could be pre-programmed to open the door facilitating easier egress from the residence. Similarly, alarm signal arriving at an automatic/smart garage opener could be used to open the garage doors to facilitate egress and alert passers by of the fire event.

In some embodiments, the interface module 110 may include interfaces that may employ communication techniques such as, but not limited to, code-division multiple access (CDMA), high-speed packet access (HSPA+), global system for mobile communications (GSM), long-term evolution (LTE), WiMax, etc. In an embodiment, the interface module 110 may include a network interface to employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. In some embodiments, the interface module 110 may be communicably coupled with the one or more external devices 121 via a communication network that may include, without limitation, a direct interconnection, local area network (LAN), wide area network (WAN), wireless network (e.g., using Wireless Application Protocol), the Internet, etc.

The power unit 111 may be configured to supply power to the sensing unit 102, the processing unit 106, the alert generation unit 108, and/or the interface module 110 via an Alternating Current (AC) power supply 120, an external Direct Current (DC) power source 122, or a DC power source 115 (also referred to as the internal DC power source 115).

In an embodiment, the power unit 111 may be include a pluggable power interface 112 to enable a connection of the portable fire alarm device 100 with an Alternating Current (AC) outlet to supply power to the sensing unit 102, the processing unit 106, the alert generation unit 108, and/or the interface module 110 to generate the alert. The power unit 111 may further include a power interface 114 to enable a connection of the portable fire alarm with the external Direct Current (DC) power source 122 to supply power to the sensing unit 102, the processing unit 106, the alert generation unit 108, and/or the interface module 110 to generate the alert. In a non-limiting example, the external DC power source 122 may include a battery powered device. Moreover, the power unit 111 may include the DC power source 115 to supply power to the sensing unit 102, the processing unit 106, the alert generation unit 108, and/or the interface module 110 to generate the alert. Embodiments are exemplary in nature, and the power unit 111 may be configured to supply the required to each component of the device 100.

The power unit 111 may suitably convert the power from various sources such as, the DC power source 115, the AC power supply 120, and the external DC power source 122, to support different power requirements of the various components of the device 100. The conversion may include, but not limited to, AC to DC conversion, DC to AC conversion, power-up conversion, power down conversion, and so forth. The power unit 111 may be also configured to perform functions such as, but not limited to, power distribution, power backup support, power monitoring, over-current and overvoltage protection, power compatibility conversion, power safety compliance regulation, and so forth.

Further, the device 100 may include a memory (not shown) configured to store data and/or instructions for the processing unit 106 and/or the alert generation unit 108 to perform the desired functions of the device 100. The memory may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

Embodiments are exemplary in nature, and the device 100 may include any suitable components that are required to detect a potential fire hazard effectively and efficiently.

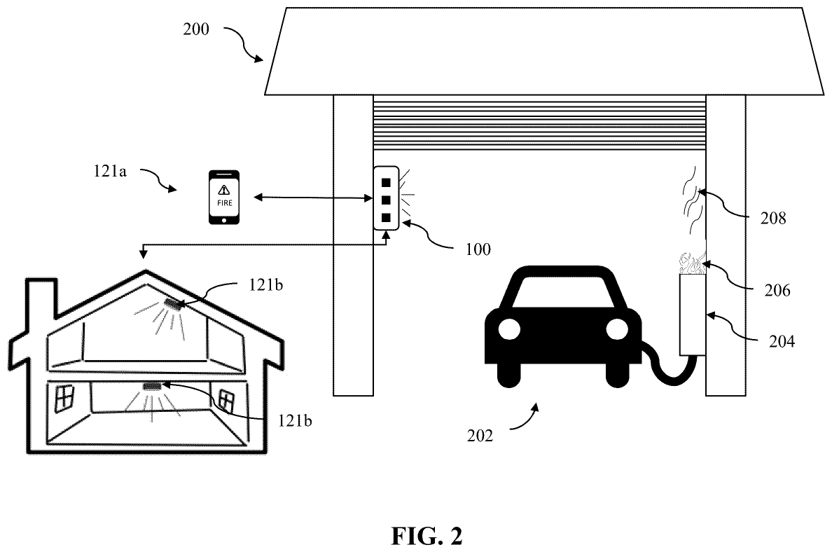

FIG. 2 illustrates an exemplary system environment 200 of the portable fire alarm device 100, according to one or more embodiments of the disclosure. The system environment 200 may correspond to a garage where an electric vehicle 202 is parked. However, the illustrated embodiment of FIG. 2 is exemplary in nature, and the system environment 200 may correspond to any other confined space with battery-based devices. Examples of such environment may include, but not limited to, remote storage sheds with battery-based devices, covered electric vehicle charging stations, workshops with battery-based devices, and remote manufacturing facilities with battery-based devices. The battery-based devices may include devices that are primarily based on a battery source (such as, a Li-ion battery, a lead-acid battery, etc.) for power supply. The electric vehicle 202 is also connected to a charging station 204. In the illustrated scenario, due to overheating the charging station 204 catches fire 206. The resulting fire 206 emits flames/smoke 208. The device 100 may be plugged to an AC outlet and detects the fire 206 based on the detected flames/smoke 208 and/or a temperature of the system environment 200. The device 100 may generate an alert in response to detecting the fire 206. The device 100 may also transmit the information of the alert to the one or more external device 121 such as, a mobile phone 121a of the user or alarm devices 121b of a building.

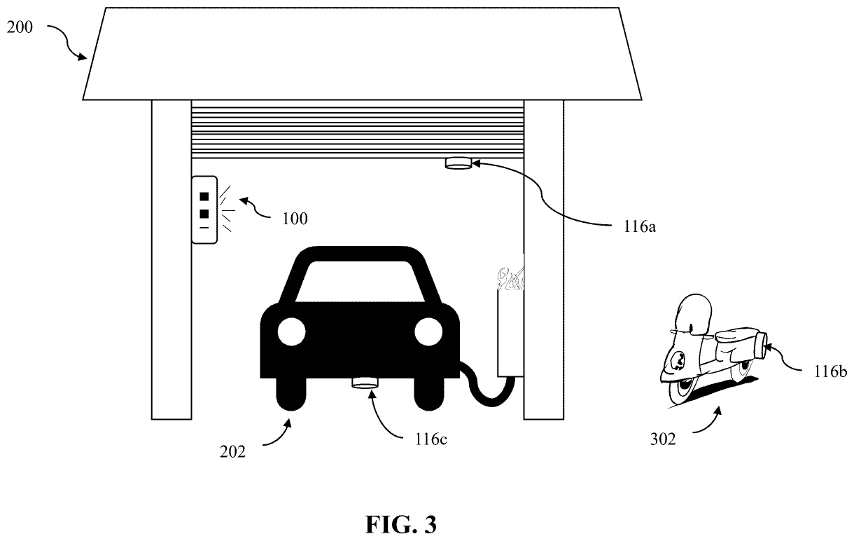

FIG. 3 illustrates another system environment of the portable fire alarm device 100, according to one or more embodiments of the disclosure. FIG. 3 illustrates the device 100 collecting signals from one or more remote sensor devices 116a-116c disposed in the environment. A first remote sensor device 116a may be disposed at a ceiling of the system environment 200, a second remote sensor device 116b may be attached to a first battery based object (for example, an electric two-wheeler 302) of the user, and a third remote sensor device 116c may be attached to a second battery based object (for example, the electric vehicle 202 with a battery) of the user. The remote sensors devices 116a-116c may enable early detection of potential fire hazard.

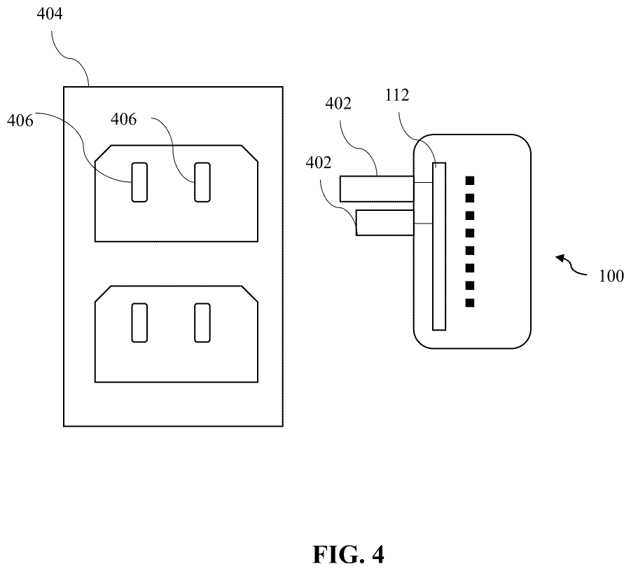

FIG. 4 illustrate a pluggable configuration of the portable fire alarm device 100, according to one or more embodiments of the disclosure. The device 100 may include a plurality of pluggable pins 402 that enables the device to be plugged to an AC outlet 404. The AC outlet 404 may be positioned at any suitable location on a wall, ceiling, or floor, and connected to a power supply. The AC outlet 404 may provide any suitable voltage configuration such as, 120 volts, 240 volts, 380 volts, or other voltage configurations, that is suitable for the operation of the device 100. The pluggable pins 402 may be connected to the pluggable power interface 112 of the device 100. The pluggable pins 402 may corresponds to the pluggable power interface 112 of the power unit 111. For instance, the power unit 111 may act as Analog to Digital Converter (ADC) to convert the received AC power supply to corresponding DC power to support power requirements of various components of the device 100. The power unit 111 may also act as an amplifier to modify a power level of the received power to support the power requirements of the device 100. The power unit 111 may include a step-up transformer or a step-down transformer to meet the specific power requirement of the device 100.

In an exemplary embodiment, the device 100 may be plugged into a pair of outlets 406 of the AC outlet 404. However, embodiments are exemplary in nature and the device 100 and/or the AC outlet 404 may include any number of the pluggable pins 402 and corresponding outlets 406 to support the power requirement of the device 100. The pluggable configuration device 100 enables easy installation of device 100 at any suitable location.

In alternative embodiments, the device 100 may be connected to the AC power supply via other suitable means, such as direct wire connection, screw connection with lamp connector, and so forth. In some embodiments, the device 100 may be placed in semi-permanent manner, at a location where the device 100 can monitor hazardous condition of a target environment.

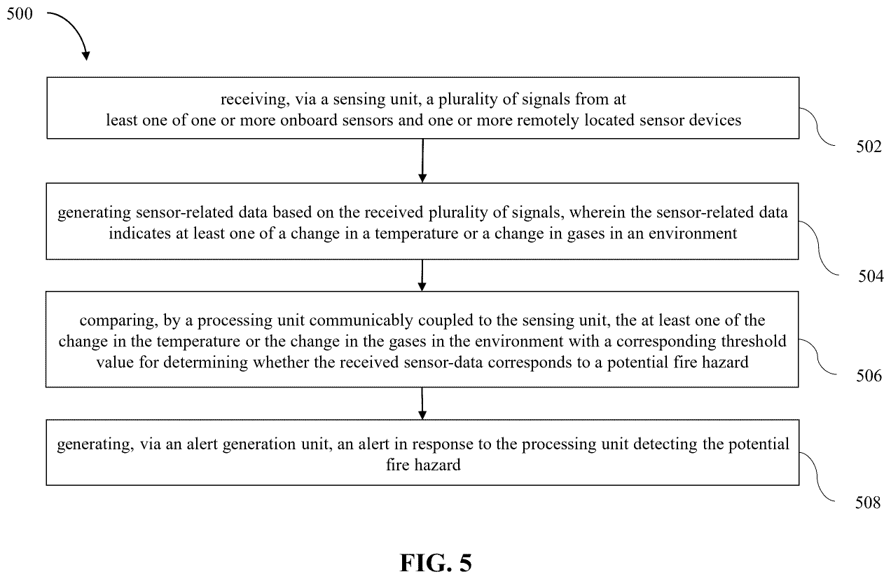

FIG. 5 illustrates a process flow depicting a method 500 of operating the portable fire alarm device 100, according to one or more embodiments of the disclosure.

At step 502, the method 500 comprises receiving, via a sensing unit, a plurality of signals from at least one of the one or more on-board sensors 104 and the one or more remotely located sensor devices 116.

At step 504, the method 500 comprises generating sensor-related data based on the received plurality of signals. In one embodiment, the sensor-related data indicates at least one of a change in a temperature or a change in gases in an environment.

At step 506, the method 500 comprises comparing, by a processing unit communicably coupled to the sensing unit, the at least one of the change in the temperature or the change in the gases in the environment with a corresponding threshold value for determining whether the received sensor-data corresponds to a potential fire hazard.

At step 508, the method 500 comprises generating, via an alert generation unit, an alert in response to the processing unit detecting the potential fire hazard.

While the above steps of FIG. 5 are shown and described in a particular sequence, the steps may occur in variations to the sequence in accordance with various embodiments of the disclosure. Further, the details related to various steps of FIG. 5, which are already covered in the description related to FIGS. 1-4 are not discussed again in detail here for the sake of brevity.

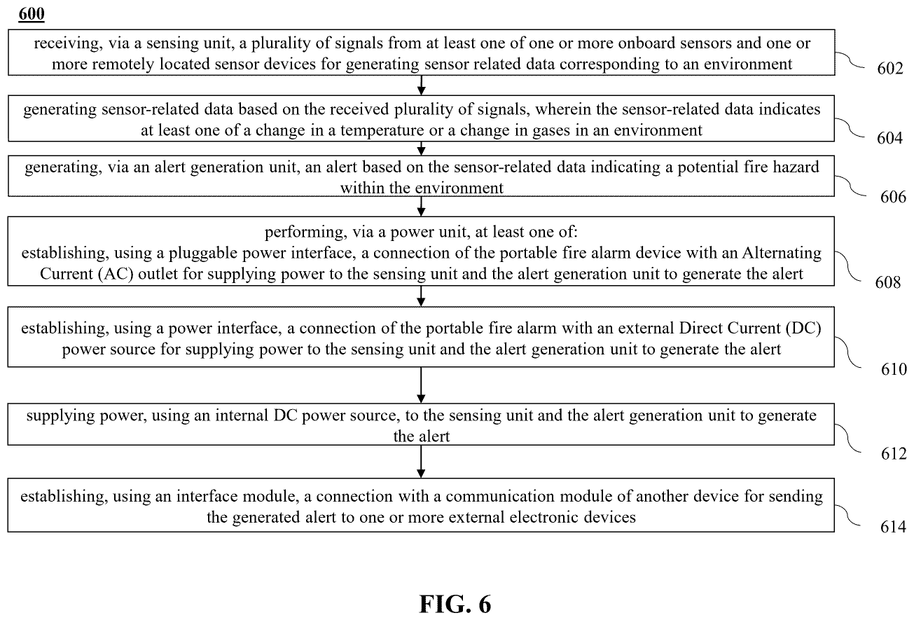

FIG. 6 illustrates another process flow depicting a method 600 of operating the portable fire alarm device 100, according to one or more embodiments of the disclosure.

At step 602, the method 600 comprises receiving, via the sensing unit 102, a plurality of signals from at least one of the one or more on-board sensors 104 and the one or more remotely located sensor devices 116 for generating sensor related data corresponding to an environment.

At step 604, the method 600 comprises generating sensor-related data based on the received plurality of signals. The sensor-related data indicates at least one of a change in a temperature or a change in gases in an environment.

At step 606, the method 600 comprises generating, via the alert generation unit 108, an alert based on the sensor-related data indicating a potential fire hazard within the environment.

At step 608, the method 600 comprises performing, via the power unit 111, at least one of establishing, using the pluggable power interface 112, a connection of the portable fire alarm device with an Alternating Current (AC) outlet for supplying power to the sensing unit 102 and the alert generation unit 108 to generate the alert.

At step 610, the method 600 comprises performing, via the power unit 111, at least one of establishing, using the power interface 114, a connection of the portable fire alarm with the external Direct Current (DC) power source 122 for supplying power to the sensing unit 102 and the alert generation unit 108 to generate the alert. The external DC power source 122 comprises a battery powered device.

At step 612, the method 600 comprises performing, via the power unit 111, at least one of supplying power, using the internal DC power source 115, to the sensing unit 102 and the alert generation unit 108 to generate the alert.

At step 614, the method 600 comprises establishing, using the interface module 110, a connection with a communication module of another device for sending the generated alert to one or more external electronic devices. The another device comprises at least one of a smart lock device, an Internet of Thing (IoT) home device, and an external alarm system.

While the above steps of FIG. 6 are shown and described in a particular sequence, the steps may occur in variations to the sequence in accordance with various embodiments of the disclosure. Further, the details related to various steps of FIG. 6, which are already covered in the description related to FIGS. 1-4 are not discussed again in detail here for the sake of brevity.

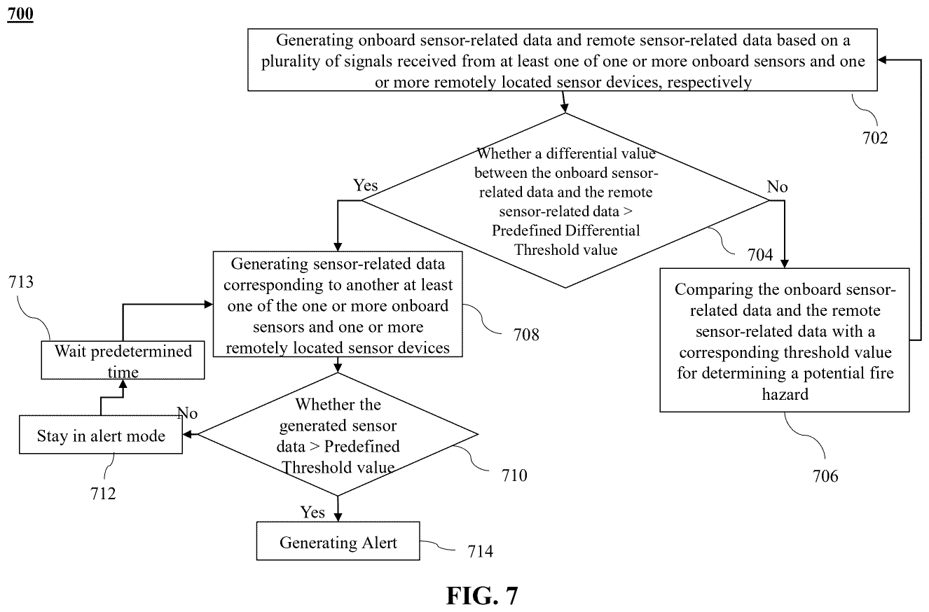

FIG. 7 illustrates another process flow depicting a method 700 of operating the portable fire alarm device 100, according to one or more embodiments of the disclosure.

At step 702, the method 700 comprises generating on-board sensor-related data and remote sensor-related data based on a plurality of signals received from at least one of the one or more on-board sensors 104 and the one or more remotely located sensor devices 116, respectively. The method 700 further comprises determining a differential value between the on-board sensor-related data and the remote sensor-related data. For instance, the generated on-board sensor-related data and the remote sensor-related data correspond to a change in temperature as determined by the at least one of the one or more on-board sensors 104 and the one or more remotely located sensor devices 116. Further, the differential value between the on-board sensor-related data and the remote sensor-related data is T.

At step 704, the method 700 comprises determining whether the determined differential value between the on-board sensor-related data and the remote sensor-related data exceeds a predefined differential threshold value. For instance, the predefined differential threshold value is 40 F. The method comprises 700 determining whether the determined threshold value T exceeds the predefined different value of 40 F, i.e., whether T>40 F.

At step 706, upon determining that the determined differential value does not exceed the predefined differential threshold value, the method 700 comprises comparing the on-board sensor-related data and the remote sensor-related data with a corresponding threshold value for determining a potential fire hazard. Further, the method 700 comprises re-performing step 702 upon determining that there is no potential fire hazard.

At step 708, upon determining that the determined differential value exceeds the predefined differential threshold value, the method 700 comprises generating sensor-related data and corresponding differential value corresponding to another at least one of the one or more on-board sensors 104 and the one or more remotely located sensor devices 116. For example, the sensor-related data and the corresponding differential value corresponds to a change in gases as determined by the another at least one of the one or more on-board sensors 104 and the one or more remotely located sensor devices 116.

At step 710, the method 700 comprises determining whether the generated sensor data exceed the corresponding predefined threshold value.

At step 712, upon determining that the generated sensor-related data and/or the corresponding differential value of the another at least one of the one or more on-board sensors 104 and the one or more remotely located sensor devices 116 does not exceed the corresponding predefined threshold value, the method 700 comprises keeping the portable fire alarm device 100 on alert and continuing monitoring of the environment. Further, at step 713, the method 700 comprises waiting for a predetermined time and on an expiry of the predetermined time the method 700 comprises re-performing step 708.

At step 714, upon determining that the generated sensor-related data and/or corresponding differential value of the another at least one of the one or more on-board sensors 104 and the one or more remotely located sensor devices 116 exceeds the corresponding predefined threshold value, the method 700 comprises generating the alert, as discussed above.

While the above steps of FIG. 7 are shown and described in a particular sequence, the steps may occur in variations to the sequence in accordance with various embodiments of the disclosure. Further, the details related to various steps of FIG. 7, which are already covered in the description related to FIGS. 1-4 are not discussed again in detail here for the sake of brevity.

The disclosure provides a portable fire alarm device that is compact, easy to install, and has effective power supply system. The portable fire alarm device is adaptable and configured to a plurality of sensors to effectively detect a potential fire hazard.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

I/We claim:

1. A portable fire alarm device, comprising:
a sensing unit configured to receive a plurality of signals from at least one of one or more on-board sensors and one or more remotely located sensor devices to generate sensor related data corresponding to an environment;
an alert generation unit configured to generate an alert based on the sensor-related data indicating a potential fire hazard within the environment;
a power unit comprising at least one of:
a pluggable power interface to enable a connection of the portable fire alarm device with an Alternating Current (AC) outlet to supply power to the sensing unit and the alert generation unit to generate the alert;
a power interface to enable a connection of the portable fire alarm with an external Direct Current (DC) power source to supply power to the sensing unit and the alert generation unit to generate the alert; and
an internal DC power source configured to supply power to the sensing unit and the alert generation unit to generate the alert; and
an interface module configured to establish a connection with a communication module of another device to send the generated alert to one or more external electronic devices.

2. The portable fire alarm device of claim 1, wherein the at least one of the one or more on-board sensors and the one or more remotely located sensor devices comprise at least one of a temperature sensor, a gas sensor, a smoke sensor, and a flame sensor.

3. The portable fire alarm device of claim 1, wherein the sensor-related data indicates at least one of a change in temperature, a detection of flame, a detection of a target gas, or a detection of smoke in the environment.

4. The portable fire alarm device of claim 3, wherein the alert generation unit is configured to compare the at least one of the change in the temperature, the detection of flame, the detection of the target gas, or the detection of smoke in the environment with a corresponding predefined criteria to determine whether the received sensor-data corresponds to the potential fire hazard.

5. The portable fire alarm device of claim 1, wherein the alert corresponds to at least one of an activation of one or more visual indicators, an activation of a sound signal, or a combination thereof.

6. The portable fire alarm device of claim 1, wherein the external DC power source comprises a battery powered device.

7. The portable fire alarm device of claim 1, wherein the another device comprises at least one of a smart lock device, an Internet of Thing (IoT) home device, and an external alarm system.

8. The portable fire alarm device of claim 1, wherein the sensor-related data indicates at least one of a change in a temperature or a change in gases in an environment, and the alert generation unit is configured to:
determine whether the at least one of the change in the temperature or the changes in the gases in the environment exceeds a corresponding predefined threshold value; and
generate the alert based on a determination that the at least one of the change in the temperature or the changes in the gases in the environment exceeds the corresponding predefined threshold value.

9. A method of operation of a portable fire alarm device, comprising:
receiving, via a sensing unit, a plurality of signals from at least one of one or more on-board sensors and one or more remotely located sensor devices for generating sensor related data corresponding to an environment;
generating, via an alert generation unit, an alert based on the sensor-related data indicating a potential fire hazard within the environment;
performing, via a power unit, at least one of:
establishing, using a pluggable power interface, a connection of the portable fire alarm device with an Alternating Current (AC) outlet for supplying power to the sensing unit and the alert generation unit to generate the alert;
establishing, using a power interface, a connection of the portable fire alarm with an external Direct Current (DC) power source for supplying power to the sensing unit and the alert generation unit to generate the alert; and
supplying power, using an internal DC power source, to the sensing unit and the alert generation unit to generate the alert; and
establishing, using an interface module, a connection with a communication module of another device for sending the generated alert to one or more external electronic devices.

10. The method of claim 9, wherein the at least one of the one or more on-board sensors and the one or more remotely located sensor devices comprise at least one of a temperature sensor, a gas sensor, a smoke sensor, and a flame sensor.

11. The method of claim 9, wherein the sensor-related data indicates at least one of a change in temperature, a detection of flame, a detection of a target gas, or a detection of smoke in the environment.

12. The method of claim 11, further comprising:
comparing the at least one of the change in the temperature, the detection of flame, the detection of the target gas, or the detection of smoke in the environment with a corresponding predefined criteria for determining whether the received sensor-data corresponds to the potential fire hazard.

13. The method of any of claim 9, wherein the alert corresponds to at least one of an activation of one or more visual indicators, an activation of a sound signal, or a combination thereof.

14. The method of any of claim 9, wherein the external DC power source comprises a battery powered device.

15. The method of any of claim 9, wherein the another device comprises at least one of a smart lock device, an Internet of Thing (IoT) home device, and an external alarm system.

16. The method of claim 9, wherein the sensor-related data indicates at least one of a change in a temperature or a change in gases in an environment, and the method further comprises:
determining whether the at least one of the change in the temperature or the changes in the gases in the environment exceeds a corresponding predefined threshold value; and
generating the alert based on a determination that the at least one of the change in the temperature or the changes in the gases in the environment exceeds the corresponding predefined threshold value.
